(19) United States
(12) Patent Application Publication
(10) Pub. No.: US 2015/0102998 A1
(43) Pub. Date: Apr. 16, 2015

(54) PROJECTION-TYPE PROJECTOR, ANTI-GLARE METHOD, AND PROGRAM FOR ANTI-GLARE

(71) Applicant: NEC Corporation, Minato-ku, Tokyo (JP)

(72) Inventor: Ryoma Oami, Tokyo (JP)

(73) Assignee: NEC CORPORATION, Minato-ku (JP)

(21) Appl. No.: 14/394,819

(22) PCT Filed: May 21, 2013
(86) PCT No.: PCT/JP2013/003223

§ 371 Date: Oct. 16, 2014

(30) Foreign Application Priority Data
Jun. 15, 2012 (JP) 2012-135400

(51) Int. Cl. G06F 3/01; H04N 5/74

(52) U.S. Cl. CPC G06F 3/012; H04N 5/74
USPC 345/156

(57) ABSTRACT

A head detection means 81 detects a head region of a moving object from a captured image that is an image obtained by capturing both of a projected image projected from a projection means and the moving object. A motion detection means 82 calculates a moving direction and a moving amount of the head of the moving object, based on a time-series change in the head region detected from the captured image. An anti-glare processing means 83 performs a process of reducing glare on respective pixels of the projected image corresponding to the head region. Also, the anti-glare processing means 83 changes pixels to be subjected to the process of reducing glare, based on the moving direction and the moving amount.

### TECHNICAL FIELD

The present invention relates to a projection-type projector, an anti-glare method, and a program for anti-glare, which reduce glare of light projected when an image is projected.

### BACKGROUND ART

When a presenter gives a presentation by using a projector for projecting an image on a screen, the presenter has many opportunities to stand in front of the projected image and make an explanation. In this case, since light projected from the projector is directly irradiated on eyes of the presenter, the presenter often feels glare to the light. Therefore, there are known methods for projecting light so as to mitigate glare felt by the presenter.

Non Patent Literature 1 discloses a projector system that adjusts light of a projector such that a speaker does not feel glare even when standing in front of the projector. The projector system disclosed in Non Patent Literature 1 detects a face region of the speaker from an image including a screen and the speaker, and superimposes and displays a black circular mask image on the detected region.

Also, Non Patent Literature 2 discloses a person detection method for increasing the accuracy of detecting a person in a high brightness environment. The method disclosed in Non Patent Literature 2 detects a person by performing brightness adjustment between a projected image and a captured image, which is obtained by capturing the projected image by a camera, and generating a difference image between the brightness-adjusted images.

### CITATION LIST

### Non Patent Literature

NPL 1: Tamaki Junya, Kazuto Murakami, “A Proposal of Non-Dazzling Projector System”, Information Processing Society of Japan Technical Report, CVIM-163, Information Processing Society of Japan, May 1, 2008, p. 43-46

NPL 2: Tamaki Junya, Kazuto Murakami, “Face Detection in High Brightness Environment and its applications”, Institute of Image Information and Television Engineers (ITE) Technical Report, 33 (34), Aug. 27, 2009, p. 53-54

### SUMMARY OF INVENTION

### Technical Problem

In order to mitigate glare of a presenter, it is effective to reduce light projected on the presenter. On the other hand, a projected slide is important materials to a viewer. Therefore, it is preferable that a range of reducing the projected light is near a head of a user as much as possible. Hence, it is preferable to appropriately recognize a head of a presenter and reduce light around the head.

On the other hand, the presenter standing in front of a slide does not necessarily remain in one place when giving an explanation. The presenter may give an explanation while changing his/her position depending on, for example, contents of a slide.

A predetermined time is required to recognize the head of the presenter and reduce light around the head. That is, a predetermined processing delay occurs in order to reduce light around the head of the presenter. Therefore, in the method disclosed in Non Patent Literature 1, when the presenter moves, a portion in which light is reduced is deviated from an actual face position of the presenter, causing a problem that cannot reduce glare.

Therefore, an object of the present invention is to provide a projection-type projector, an anti-glare method, and a program for anti-glare, in which when an image is projected by projecting high-brightness light, glare of light projected on a person can be accurately reduced even though the person existing in a projection direction of the image moves.

### Solution to Problem

A projection-type projector according to the present invention includes: a head detection means for detecting a head region of a moving object from a captured image that is an image obtained by capturing both of a projected image projected from a projection means and the moving object; a motion detection means for calculating a moving direction and a moving amount of a head of the moving object, based on a time-series change in the head region detected from the captured image; and an anti-glare processing means for performing a process of reducing glare on respective pixels of the projected image corresponding to the head region, wherein the anti-glare processing means changes pixels to be subjected to the process of reducing glare, based on the moving direction and the moving amount.

An anti-glare method according to the present invention includes: detecting a head region of a moving object from a captured image that is an image obtained by capturing both of a projected image projected from a projection means and the moving object; calculating a moving direction and a moving amount of a head of the moving object, based on a time-series change in the head region detected from the captured image; and performing a process of reducing glare on respective pixels of the projected image corresponding to the head region, wherein in the process, pixels to be subjected to the process of reducing glare are changed based on the moving direction and the moving amount.

A program for anti-glare according to the present invention causes a computer to perform: a head detection process of detecting a head region of a moving object from a captured image that is an image obtained by capturing both of a projected image projected from a projection means and the moving object; a motion detection process of calculating a moving direction and a moving amount of a head of the moving object, based on a time-series change in the head region detected from the captured image; and an anti-glare process of performing a process of reducing glare on respective pixels of the projected image corresponding to the head region, wherein in the anti-glare process, pixels to be subjected to the process of reducing glare are changed based on the moving direction and the moving amount.

### Advantageous Effects of Invention

According to the present invention, when an image is projected by projecting high-brightness light, glare of light projected on a person can be accurately reduced even though the person existing in a projection direction of the image moves.

### BRIEF DESCRIPTION OF DRAWINGS

FIG. 1 It depicts a block diagram illustrating an exemplary embodiment of a projection-type projector according to the present invention.

FIG. 2 It depicts an explanatory diagram illustrating an example in which a position of a dimming region is changed.

FIG. 3 It depicts an explanatory diagram illustrating an example in which a shape of a dimming region is changed.

FIG. 4 It depicts a flowchart illustrating an operation example of a projection-type projector.

FIG. 5 It depicts a block diagram illustrating an overview of a projection-type projector according to the present invention.

### DESCRIPTION OF EMBODIMENTS

Hereinafter, exemplary embodiments of the present invention will be described with reference to the drawings.

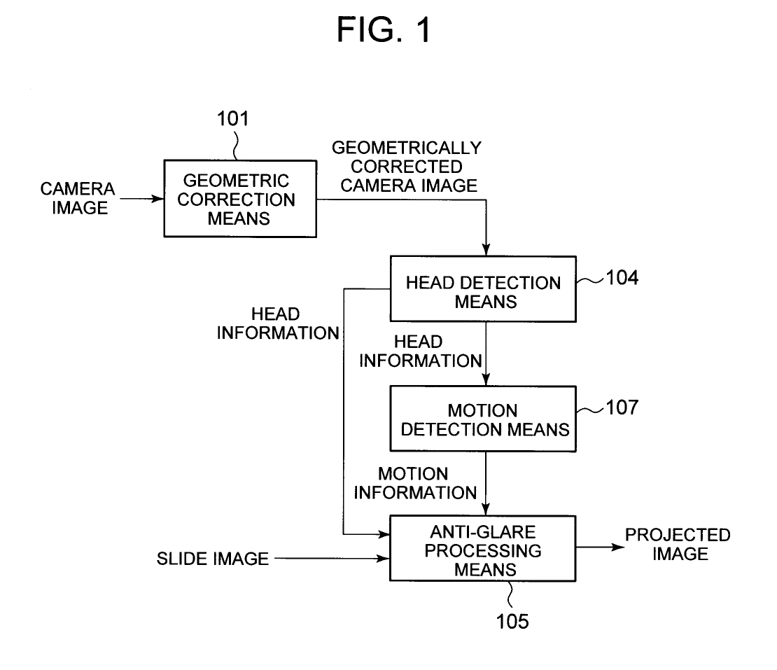

FIG. 1 depicts a block diagram illustrating an exemplary embodiment of a projection-type projector according to the present invention. The projection-type projector according to the present exemplary embodiment includes a geometric correction means 101, a head detection means 104, a motion detection means 107, and an anti-glare processing means 105.

The geometric correction means 101 has an input of an image captured by a camera (hereinafter, referred to as a camera image) and performs geometric correction on the camera image according to a shape of an image of a slide projected on a screen by the projection-type projector (hereinafter, referred to as a slide image).

Specifically, when the projector projects a rectangular slide image, the geometric correction means 101 performs geometric correction on the camera image captured by the camera such that the camera image has a rectangular shape matched with the shape of the slide image. Hereinafter, the camera image, which has been subjected to the geometric correction by the geometric correction means 101, is also referred to as a geometrically corrected image. A geometric correction method uses a well-known general method, such as a method using a projection transformation matrix.

Herein, the camera image is an image obtained by capturing a slide image projected to a screen. Also, when a presenter gives an explanation while standing in front of the slide image projected on the screen, the presenter exists between the slide image and the projector. In this case, the camera image refers to an image obtained by capturing the presenter together with the slide image. In the present exemplary embodiment, the term “camera image” as used herein refers to an image obtained by capturing the slide image or an image obtained by capturing both the slide image and the presenter.

Also, since the presenter captured as the camera image is an object that moves during the projection of the slide image, the presenter may be also referred to as a moving object in the following description. Also, from the viewpoint of the viewer of the slide, the slide image may be referred to as a background, and the presenter existing in front of the slide image may be referred to as a foreground.

The head detection means 104 detects a head region of the moving object from the camera image. The head detection means 104 may detect a head through pattern recognition by using, for example, a template or a feature describing a pattern of the head when viewed from various directions of 360 degrees. Also, since a method for detecting a head region from an image including a person is well known, a detailed description thereof will be omitted.

The head detection means 104 inputs information indicating the detected head region (hereinafter, also referred to as head information) to the motion detection means 107 and the anti-glare processing means 105.

The motion detection means 107 detects a motion of the moving object. Specifically, the motion detection means 107 calculates a moving direction and a moving amount of the head of the moving object, based on a time-series change in the head region detected from the camera image. The moving amount of the head is, for example, a speed at which the head moves.

The motion detection means 107 may calculate the moving direction and the moving amount of the head by, for example, comparing head information of a frame input from the head detection means 104 with head information of a previously input frame. That is, the motion detection means 107 may calculate the moving direction and the moving amount of the moving object, based on a change between frames of the head region detected from the camera image. In this case, the motion detection means 107 can calculate the moving amount of the moving object by calculating a difference of positions (e.g., positions of the center of the head or the center of gravity) at which the head is detected between the frames.

In addition, the motion detection means 107 may calculate a moving direction and a moving distance by using a block matching method or a template matching method with respect to corresponding points of the head between the frames. Also, since a method for calculating a moving direction and a moving amount of a moving object detected from a plurality of images by using a block matching method or a template matching method is well known, a detailed description thereof will be omitted.

Therefore, the motion detection means 107 may use any methods as long as the methods can calculate the moving direction and the moving amount of the head from information indicating the position of the head region which changes in time series.

The anti-glare processing means 105 performs a process of reducing glare for each pixel of a slide image corresponding to the head region. In this case, the anti-glare processing means 105 changes pixels to be subjected to the process of reducing glare, based on the moving direction and the moving amount of the head calculated by the motion detection means 107.

Specifically, the anti-glare processing means 105 changes a position or a shape of a region (hereinafter, also referred to as a dimming region) in which brightness is reduced, based on the moving direction and the moving amount of the head. When the moving amount is large, the anti-glare processing means 105 may move the dimming region in the moving direction or may increase the dimming area in the moving direction. For example, when the moving direction is a lateral direction, the anti-glare processing means 105 considers that a horizontally long ellipse having a long major axis in proportion to the magnitude of the moving amount is applied as the dimming region.

The anti-glare processing means 105 may determine a shape (e.g., an elliptical shape) of the dimming region whenever anti-glare processing is performed. For example, when the moving amount is larger than a predetermined threshold value (i.e., when the speed of the moving object become faster), the anti-glare processing means 105 may increase the dimming region in the moving direction. In this manner, since the anti-glare processing is performed in a direction in which the moving object moves, it is possible to accurately reduce glare of light projected on the moving object.

On the other hand, when the moving amount is smaller than the predetermined threshold value (i.e., the speed of the moving object become slower), the anti-glare processing means 105 may decrease the dimming region. For example, when the moving object stops, the anti-glare processing means 105 may decrease the dimming region. In this manner, unnecessary anti-glare processing is suppressed, thereby efficiently projecting the slide image.

Furthermore, the anti-glare processing means 105 may determine a shape of the dimming region according to the moving direction and the moving amount. Also, the anti-glare processing means 105 may recalculate the dimming region when an acceleration (i.e., an amount of change in the speed of the moving object) exceeds a threshold value of a predetermined range.

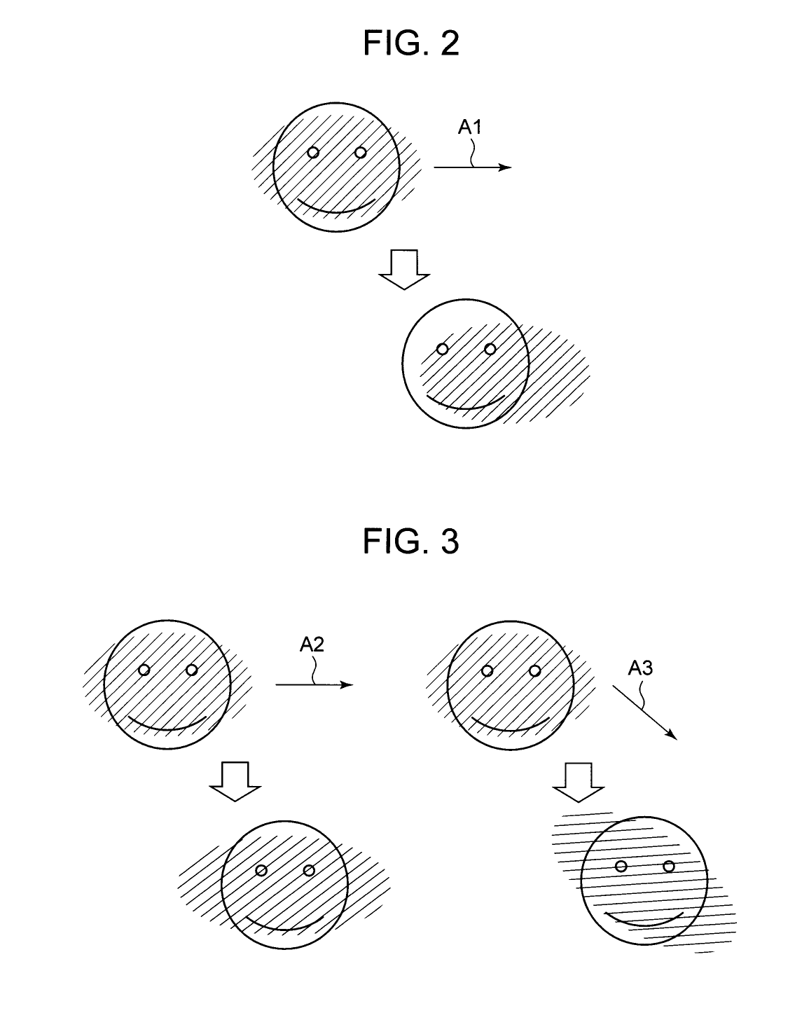

FIG. 2 depicts an explanatory diagram illustrating an example in which a position of a dimming region is changed. Also, FIG. 3 depicts an explanatory diagram illustrating an example in which a shape of a dimming region is changed.

As illustrated in FIG. 2, when it is detected that a head of a moving object moves in a right direction A1 in a state in which anti-glare processing has been performed, the anti-glare processing means 105 may move the dimming region in the right direction according to a calculated moving amount.

Also, as illustrated in FIG. 3, when it is detected that a head of a moving object moves in a right direction A2 (or in a lower right direction A3) in a state in which anti-glare processing has been performed, the anti-glare processing means 105 may change the shape of the dimming region such that the dimming region is increased in the right direction A2 (or in the lower right direction A3) according to a calculated moving amount.

The anti-glare processing means 105 may uniformly decrease brightness values of pixels included in a head region (e.g., brightness values to 0) or may decrease brightness by superimposing, on the head region, a pattern figure, such as an ellipse or a circle, the brightness of which gradually approaches to a background color as a distance from the center increases. Thus, unnecessary anti-glare processing is suppressed, thereby efficiently projecting the slide image. Also, since a boundary of the dimming region is blurred, visual impact of the dimming region can be mitigated. Also, the dimming region is not necessary to match with the head region and may be a rectangular region around the head region.

Also, when the head detection means 104 detects even a direction of the head, the anti-glare processing means 105 may reduce brightness of a region having a high possibility that eyes exists in the front of the head. Also, even when the head detection means 104 does not detect the direction of the head, considering that the head is usually likely facing to a direction in which a presenter moves, the anti-glare processing means 105 may determine that it is highly likely that an eye region exists in the moving direction detected by the motion detection means 107 in a face region. In this case, the anti-glare processing means 105 may reduce brightness around the eye region.

In this manner, by changing pixels to be subjected to the process of reducing glare, it is possible to efficiently achieve anti-glare even when there is a large motion of the moving object. Furthermore, by changing a shape in which brightness is reduced whenever anti-glare processing is performed, it is possible to accurately reduce glare of light projected on the moving object.

Also, when the position, size, or shape of the dimming region is rapidly changed, it is apprehended that the dimming region is rather noticeable because the dimming region is non-continuously viewed. In order to avoid this, the anti-glare processing means 105 may perform a process of smoothing a change in the position, size, or shape of the dimming region in a time direction (hereinafter, also referred to as a smoothing process).

Hereinafter, the process in which the anti-glare processing means 105 smoothes the change in the position of the dimming region in the time direction will be described. A current time is set as t and a time prior to the current time is set as t-n (n=1, 2, . . . , N). Also, a position of the dimming region on an image at time t-n is set as V(t-n) and a position of the dimming region calculated considering the motion of the head at the current time t is set as X(t). In this case, the position V(t) after the dimming region is smoothed in the time direction at the time t is calculated by using Formula 1 below.

V(t)=S(X(t),V(t-1),V(t-2), . . . ,V(t-N)) (Formula 1)

The right side of Formula 1 denotes a position smoothing function. For example, Formula 1 can be expressed as Formula 2 below.

V(t)=w₀X(t)+w₁V(t-1)+w₂V(t-2)+ . . . +w_{N}V(t-N) (Formula 2)

In Formula 2, wₙ (0) is a weighting factor and satisfies the following relationship.

w₀+w₁+w₂+ . . . +w_{N}=1

However, the position smoothing function is not limited to the contents of the right side of Formula 1. The position smoothing function may be any function expressed in other forms, as long as the function has a low-pass characteristic.

So far, the process in which the anti-glare processing means 105 smoothes the change in the position of the dimming region in the time direction has been described. Similarly, the anti-glare processing means 105 may also perform the smoothing process on a change in the size or shape of the dimming region.

The anti-glare processing means 105 may change the size of the dimming region by smoothing a size determination parameter in a time direction by using the same method as the position smoothing method. For example, when the dimming region is circular, the anti-glare processing means 105 may use the radius of the circle as the size determination parameter.

Also, the anti-glare processing means 105 may change the size of the dimming region by smoothing a shape determination parameter in a time direction by using the same method as the position smoothing method. For example, when the dimming region is elliptical, the anti-glare processing means 105 may use lengths and directions of major and minor axes of the ellipse as the size determination parameter.

Also, the anti-glare processing means 105 may change the number (N as described above) or values of weighting factors for respectively smoothing the position, the size, and the shape in a time direction. Furthermore, when there is a plurality of persons within a screen, the anti-glare processing means 105 may perform the smoothing process on the respective persons in a time direction as described above.

On the other hand, instead of calculating the dimming region whenever needed, the anti-glare processing means 105 may previously store the pattern of the region (e.g., an ellipse) in which glare is reduced according to the moving direction and the moving amount and select the pattern according to the moving direction and the moving amount calculated by the motion detection means 107. In this case, the anti-glare processing means 105 may reduce glare by superimposing a selected elliptical pattern on a location corresponding to the head region of the slide image.

Also, for example, the previously stored elliptical pattern may be a pattern determined according to eight directions, including an upward direction, a downward direction, a leftward direction, a rightward direction, and diagonal directions, and a predetermined moving amount range. In this case, the anti-glare processing means 105 may select a pattern of which the angle with respect to the moving direction is most narrow and which falls within a range of the calculated moving amount. Also, the previously stored pattern is not limited to the ellipse and may be a polygon, such as a rectangle.

Therefore, by previously setting a pattern of a region to be subjected to anti-glare processing, it is possible to reduce an operation load, as compared with the method for calculating the region to be subjected to anti-glare processing whenever needed.

Also, the anti-glare processing means 105 may change pixels to be subjected to the process of reducing glare, considering a processing delay of a process performed by the projection-type projector (specifically, the geometric correction means 101, the head detection means 104, the motion detection means 107, and the like). Specifically, the anti-glare processing means 105 predicts a position, which is changed by a moving amount corresponding to the processing delay in the moving direction of the head, as the head of the presenter when the slide image is projected. Therefore, the anti-glare processing means 105 may perform the process of reducing glare on respective pixels of a slide image corresponding to the predicted position.

Also, when the processing delay of the process performed by the projection-type projector is previously set, the anti-glare processing means 105 may predict the position of the head of the presenter according to the previously set processing delay.

Also, the anti-glare processing means 105 may dynamically calculate the processing delay of the process performed by the projection-type projector. The anti-glare processing means 105 may calculate the processing delay by calculating a time from irradiation of a specific pattern on a slide to a capture of the pattern as a camera image. In addition, the anti-glare processing means 105 may calculate the processing delay by measuring a position difference between a cut point of a slide image and a cut point of a camera image at a switching position of a slide.

Also, when the processing delay is dynamically calculated, it is considered that processing delays are not uniform and are varied within a certain range. Therefore, it is more preferable that the anti-glare processing means 105 statistically calculates the processing delay (e.g., calculates a mean or mode, or a median value) from a plurality of measurement results, instead of a single measurement result, so as to improve the accuracy of the processing delay.

The geometric correction means 101, the head detection means 104, the motion detection means 107, and the anti-glare processing means 105 are implemented by a central processing unit (CPU) of a computer which operates according to a program (anti-glare program). For example, the program may be stored in a storage unit (not shown) of the projection-type projector, and the CPU may read a program and operate as the geometric correction means 101, the head detection means 104, the motion detection means 107, and the anti-glare processing means 105 according to the program. Also, each of the geometric correction means 101, the head detection means 104, the motion detection means 107, and the anti-glare processing means 105 may be implemented by dedicated hardware.

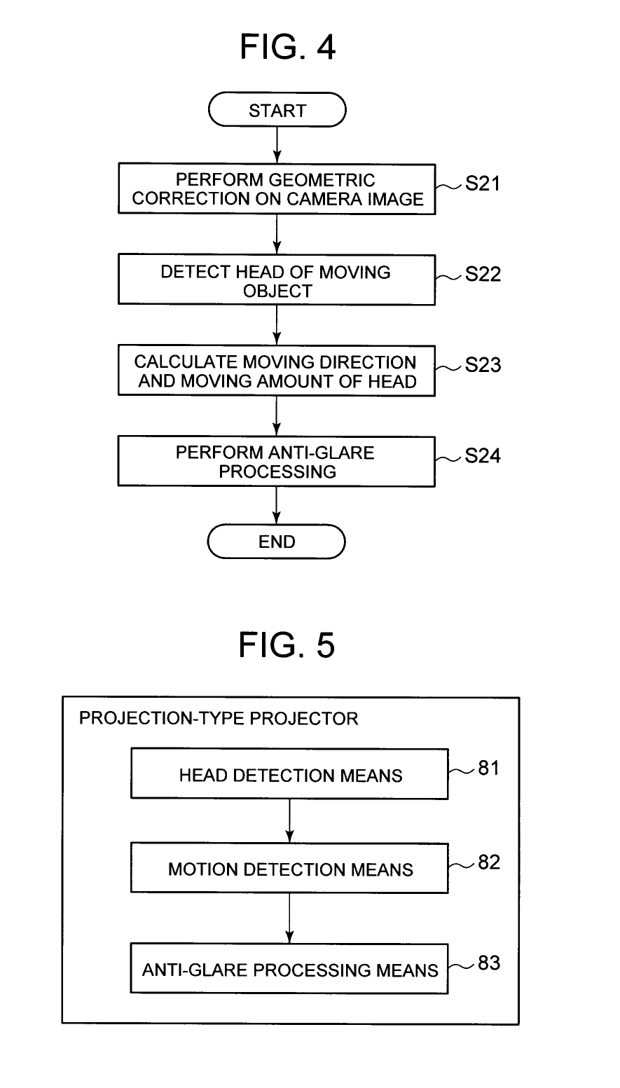

Next, the operation of the projection-type projector according to the exemplary embodiment will be described. FIG. 4 depicts a flowchart illustrating an operation example of the projection-type projector according to the present exemplary embodiment.

The geometric correction means 101 performs geometric correction on a camera image (step S21). The head detection means 104 detects a head region of a moving object from the camera image (step S22). The motion detection means 107 calculates a moving direction and a moving amount of a head of the moving object, based on a time-series change in the head region detected from the camera image (step S23).

The anti-glare processing means 105 performs a process of reducing glare on respective pixels of the slide image corresponding to the head region, based on the calculated moving direction and the calculated moving amount (step S24). For example, when the moving amount of the head exceeds a first predetermined threshold value, the anti-glare processing means 105 may increase a pixel range to be subjected to the process of reducing glare in the moving direction. In this case, the degree of the increase may become large according to the moving amount. For example, the degree of the increase may be controlled in proportion to the moving amount.

On the other hand, when the moving amount of the head falls below a second predetermined threshold value, the anti-glare processing means 105 may decrease the pixel range to be subjected to the process of reducing glare. In this case, when an eye region of the moving object is specified, the anti-glare processing means 105 may decrease a range around the eye region. Also, the first threshold value is set to be larger than the second threshold value.

As described above, according to the present exemplary embodiment, the head detection means 104 detects the head region of the moving object from the camera image, and the motion detection means 107 calculates the moving direction and the moving amount of the head of the moving object, based on the time-series change in the head region detected from the camera image. In addition, the anti-glare processing means 105 performs the process of reducing glare on respective pixels of the slide image corresponding to the head region. In this case, the anti-glare processing means 105 changes pixels to be subjected to the process of reducing glare, based on the moving direction and the moving amount.

As a result, in a case where an image is projected by projecting high-brightness light, even when a person existing in a projection direction of the image moves, it is possible to accurately reduce glare of the light projected on the person.

That is, according to the present exemplary embodiment, the motion detection means 107 detects the moving amount of the presenter, and the anti-glare processing means 105 places a region in which brightness is reduced, ahead of the moving direction of the presenter, considering the moving amount and processing delay. That is, the anti-glare processing means 105 reduces influence of the processing delay by predicting a position of the head. Therefore, even when the presenter is moving, it is possible to reduce glare caused by the projected light.

Next, an overview of a projection-type projector according to an exemplary embodiment will be described. FIG. 5 depicts a block diagram illustrating an overview of the projection-type projector according to the present invention. The projection-type projector according to the present invention includes: a head detection means 81 (e.g., the head detection means 104) for detecting a head region of a moving object from a captured image (e.g., the camera image) that is an image obtained by capturing both of a projected image (e.g., the slide image) projected from a projection means (e.g., the projector) and the moving object (e.g., the person); a motion detection means 82 (e.g., the motion detection means 107) for calculating a moving direction and a moving amount of a head of the moving object, based on a time-series change in the head region detected from the captured image; and an anti-glare processing means 83 (e.g., the anti-glare processing means 105) for performing a process of reducing glare (e.g., reducing brightness) on respective pixels of the projected image corresponding to the head region.

The anti-glare processing means 83 changes pixels to be subjected to the process of reducing glare, based on the moving direction and the moving amount.

According to the above-described configuration, in a case where an image is projected by projecting high-brightness light, even when a person existing in a projection direction of the image moves, it is possible to accurately reduce glare of the light projected on the person.

Also, when the moving amount of the head exceeds a first predetermined threshold value, the anti-glare processing means 83 may increase a pixel range to be subjected to the process of reducing glare in the moving direction. According to the above-described configuration, since the anti-glare processing is performed in a direction in which the moving object moves, it is possible to accurately reduce glare of light projected on the moving object. In this case, the degree of the increase may become large according to the moving amount. For example, the degree of the increase may be controlled in proportion to the moving amount.

Also, when the moving amount of the head falls below a second predetermined threshold value, the anti-glare processing means 83 may decrease the pixel range to be subjected to the process of reducing glare. According to the above-described configuration, unnecessary anti-glare processing is suppressed, thereby efficiently projecting the slide image.

Also, the anti-glare processing means 83 may perform a process such that brightness of respective pixels gradually approaches a background color as a distance from a center of the head region increases. According to the above-described configuration, since the anti-glare processing is performed in a direction in which the moving object moves, it is possible to accurately reduce glare of light projected on the moving object. Also, since a boundary of the dimming region is blurred, it is possible to mitigate visual impact of the dimming region.

Also, the anti-glare processing means 83 may select a predetermined pattern as a region in which glare is reduced according to the moving direction and the moving amount, and perform the process of reducing glare on pixels of a region specified by the pattern. Therefore, it is possible to reduce an operation load by previously setting a pattern of a region to be subjected to anti-glare processing, as compared with a method for calculating the region to be subjected to anti-glare processing whenever needed.

Although the present invention is described with reference to the exemplary embodiment and the examples, the invention is not limited to them. Various modifications, which can be understood by those skilled in the art, can be made to the configuration and details of the present invention, without departing from the scope of the present invention.

This application claims the priority based on Japanese Patent Application No. 2012-135400, filed on Jun. 15, 2012, the entire contents of which are incorporated herein by reference.

### INDUSTRIAL APPLICABILITY

The present invention is appropriately applied to a projection-type projector, which reduces glare of light projected when an image is projected.

### REFERENCE SIGNS LIST

101 Geometric correction means
104 Head detection means
105 Anti-glare processing means
107 Motion detection means

What is claimed is:

1. A projection-type projector comprising:
a head detection unit that detects a head region of a moving object from a captured image that is an image obtained by capturing both of a projected image projected from a projection unit and the moving object;
a motion detection unit that calculates a moving direction and a moving amount of a head of the moving object, based on a time-series change in the head region detected from the captured image; and
an anti-glare processing unit that performs a process of reducing glare on respective pixels of the projected image corresponding to the head region,
wherein the anti-glare processing unit changes pixels to be subjected to the process of reducing glare, based on the moving direction and the moving amount.

2. The projection-type projector according to claim 1, wherein when the moving amount of the head exceeds a first predetermined threshold value, the anti-glare processing unit increases a pixel range to be subjected to the process of reducing glare in the moving direction.

3. The projection-type projector according to claim 1, wherein when the moving amount of the head falls below a second predetermined threshold value, the anti-glare processing unit decreases a pixel range to be subjected to the process of reducing glare.

4. The projection-type projector according to claim 1, wherein the anti-glare processing unit performs a process such that brightness of respective pixels gradually approaches a background color as a distance from a center of the head region increases.

5. The projection-type projector according to claim 1, wherein the anti-glare processing unit smoothes a change in a pixel range to be subjected to the process of reducing glare in a time direction.

6. The projection-type projector according to claim 1, wherein the anti-glare processing unit selects a predetermined pattern as a region in which glare is reduced, based on the moving direction and the moving amount, and performs the process of reducing glare on pixels of a region specified by the pattern.

7. An anti-glare method comprising:
detecting a head region of a moving object from a captured image that is an image obtained by capturing both of a projected image projected from a projection unit and the moving object;
calculating a moving direction and a moving amount of a head of the moving object, based on a time-series change in the head region detected from the captured image; and
performing a process of reducing glare on respective pixels of the projected image corresponding to the head region, wherein in the process, pixels to be subjected to the process of reducing glare are changed based on the moving direction and the moving amount.

8. The anti-glare method according to claim 7, wherein when the moving amount of the head exceeds a first predetermined threshold value, a pixel range to be subjected to the process of reducing glare is increased in the moving direction.

9. A non-transitory computer readable information recording medium storing a program for anti-glare, when executed by a processor, that performs a method for:
detecting a head region of a moving object from a captured image that is an image obtained by capturing both of a projected image projected from a projection unit and the moving object;
calculating a moving direction and a moving amount of a head of the moving object, based on a time-series change in the head region detected from the captured image; and
performing a process of reducing glare on respective pixels of the projected image corresponding to the head region, wherein in the process, pixels to be subjected to the process of reducing glare are changed based on the moving direction and the moving amount.

10. The non-transitory computer readable information recording medium according to claim 9, wherein when the moving amount of the head exceeds a first predetermined threshold value, a pixel range to be subjected to the process of reducing glare is increased in the moving direction.
